(19) United States
(12) Patent Application Publication
(10) Pub. No.: US 2021/0012330 A1
(43) Pub. Date: Jan. 14, 2021

(54) Service Machine

(71) Applicant: Robert Luzio, Riverside, CA (US)

(72) Inventor: Robert Luzio, Riverside, CA (US)

(21) Appl. No.: 16/505,385

(22) Filed: Jul. 8, 2019

(51) Int. Cl. G06Q 20/38; G06Q 20/18

(52) U.S. Cl. CPC G06Q 20/389; G06Q 20/18; G06Q 20/065; G06Q 2220/00; H04L 2209/56

(57) ABSTRACT

This document describes a system and method for activating a service machine. The system and method enables a previous customer of goods or services to provide evidence of a previous purchase and be granted access to use the service machine based on the previous purchase. A network based system is described where verification may be performed remotely. Stand-alone mechanisms are also presented where verification can be performed through more direct interactions with the service machine.

### FIELD OF INVENTION

The present invention relates to systems which control access to service machines, particularly through confirmation of previous purchases.

### BACKGROUND AND RELATED ART

Product and service vending machines have made transacting for goods and services faster and more convenient than ever before. A number of technologies have contributed to this convenience. For example, U.S. Pat. No. 7,085,556 issued to Offer in 2006 discloses a system for cashless transactions on a vending machine, where a purchase can be facilitated, in part, by a mobile phone. Prior to this, numerous technologies have been developed to enable purchase via credit card insertion/swipe, and/or coin or bill insertion. Modern vending machines can also be more convenient for vendors, as electronic transactions can often increase the capacity of vending machines to provide service for longer periods of time without risking the accumulation of cash.

In a variety of industries, however, it is desirable to provide complimentary access to certain machines with the purchase of some good or service, while charging a fee for access to such machines to non-customers. One example is in service station air and water. In the 1980's the service station air and water industry was transformed as more fuel stations became self service with a convenient pay at pump function that reduced the likelihood that customers would interact with fuel station attendants. At the same time, stand-alone air and water dispensers became more common and an industry emerged around providing the service and maintaining the air and water machines for fuel stations. Customers benefited from the convenience, fuel stations enjoyed revenue sharing and could offer more services to customers without having to maintain the machines, and the companies managing the machines benefited by receiving revenue from its coin operation. The arrangement can work well, generally, where there is sufficient paid use of the machines and where vandalism and use damage are minimal.

There are other factors that can impact the commercial viability of operating air and water machines. For example, a California law promoting safe and efficient tire pressures requires that air and water be available for free to customers at gas stations. Where machines are cash or card operated, another mechanism must be provided to enable customers to obtain the air service for free. Typically, this is accomplished by providing the fuel station attendant with a wireless remote that bypasses the pay mechanism of the air and water machine. As incentives are not always in complete alignment, the attendant may be motivated to use the remote far more often than is required, reducing revenue for both the operator/maintainer of the machine and the fuel station itself. More significantly, the remote activation can pose a danger to service personnel, as the machines can be activated without warning by someone who may not be looking at it. Even when the remotes are used as directed, batteries that power the remote must be periodically changed, resulting in additional service calls and operating costs.

Other efforts to provide a free service to customers have involved making a “code of the day” available from an attendant within the fuel station. This strategy can addresses the battery service call issue by doing away with the remote altogether. It does very little, however, to limit the sharing of the activation code to non-customers by attendants.

Removing the bypass ability altogether solves the problem of lost revenue and some of the safety concerns. Such a configuration, however, may put the fuel station in violation of the laws of California and other states.

What is needed is a system is capable of activating a machine contingent on validation of a previously made purchase.

### SUMMARY OF INVENTION

The present invention addresses several of these issues by establishing an automated system to verify the purchase of some auxiliary good or service. Customers may be provided with a code when they make a purchase, for example, on the receipt of a fuel purchase. By making a phone call to a phone number corresponding to the machine and entering said code, the machine is unlocked. This code may also be validated through other means, such as keypads or code scanners. Alternatively, the machine may be activated through conventional payment methods, such as credit cards, coins, paper and other currency.

### DESCRIPTION OF THE DRAWINGS

FIG. 1 is a service machine suitable for use with the present invention.

FIG. 2 shows a partial assembly of components embodying the present invention.

FIG. 3 shows an overview of a user might obtain air or water service using the invention.

FIG. 4 is a flowchart demonstrating how a customer might interact with an embodiment of the invention.

FIG. 5 is a flowchart demonstrating how a service machine might handle an interaction with a customer.

FIG. 6 is a flowchart demonstrating a system architecture for a service machine.

### DETAILED DESCRIPTION

In Operation

In a typical embodiment of the invention, a customer (at a gas station, for example) is provided a code upon making a purchase. The code might be printed on the customer's receipt. The customer would like to use a service machine (say an air and water machine) associated with the gas station and the gas station would like to offer the service for no fee (or a reduced fee) to the customer. The customer finds a telephone number and instructions printed on the air and water machine. Calling the phone number connects the user to an automated system and prompts the customer to enter a machine identification number and access code. The automated system, which may receive access codes over a network in advance, validates the access code and sends a signal over a network to activate the air and water machine for several minutes. In the above scenario, activation of the service machine was authorized based on a prior purchase and required neither an action by a gas station clerk nor the activation of a designated battery operated wireless remote.

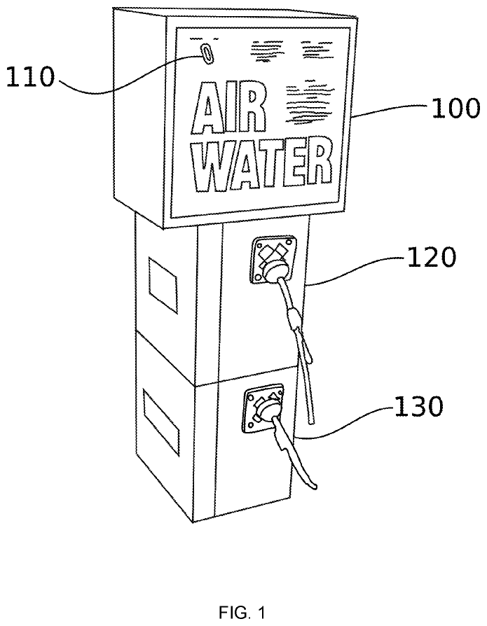

FIG. 1 shows an example of a service machine that can be equipped according to the present invention. This embodiment appears as a typical air and water machine. The air is provided through one valve and retracting hose reel 120 and the water is provided through another valve and retracting hose reel 130. The compressor for the air and associated control electronics are typically housed in the main cabinet 100. A coin slot 110 appears on the main cabinet 100. Other variations may include keypads, credit card readers and other payment mechanisms. In a preferred embodiment of the present invention, the main cabinet 100 could additionally contain a module to verify a previous purchase and trigger the activation of the service machine without payment or with a reduced payment.

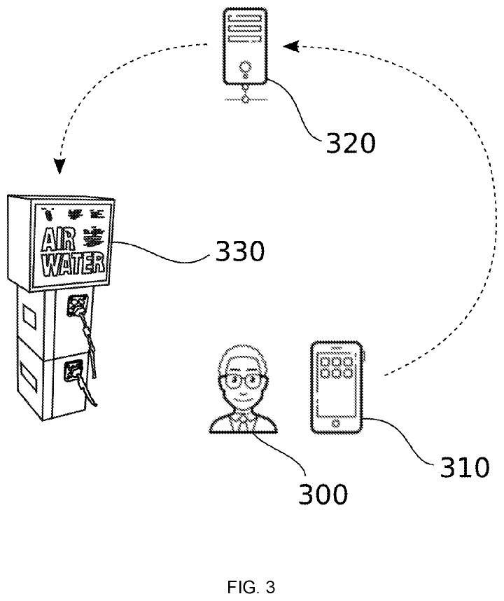

FIG. 3 shows an overview of an example user interaction to activate an air and water service machine 330. The user 300 has made a previous purchase and has some piece of information as a result of the purchase. Using a telephone or mobile device 310, the user 300 calls or otherwise interacts with a system 320 such as a voice response system to deliver evidence of the previous purchase. The system 320, in turn, may confirm a portion of the information received from the user 300 and then send an activation signal to the service machine 330 over a network. Upon successful verification, the service machine 330 provides the user 300 with the requested service.

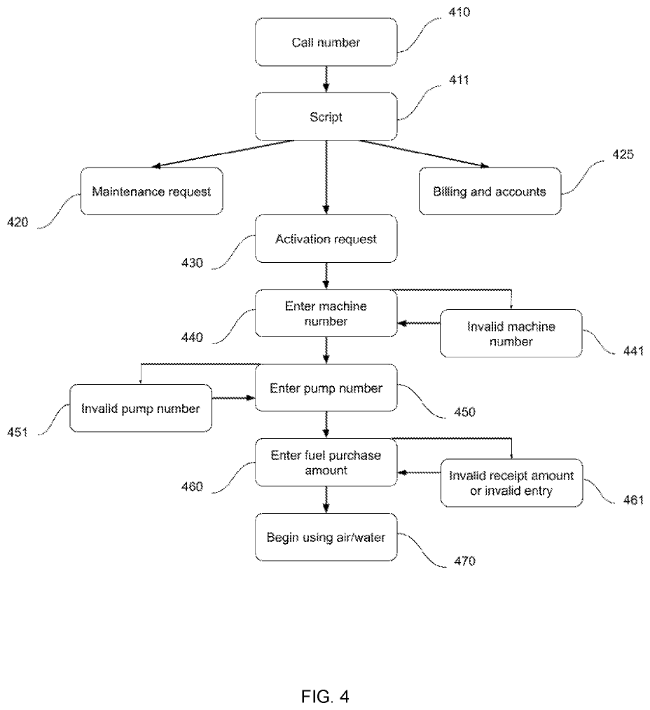

FIG. 4 shows how the customer may interact with the invention as embodied in an automotive air and water machine. In such a case, the user may be provided with a machine identification number on the air and water machine, and a pump identification number on the pump at which they purchased fuel. The user may begin by calling a number 410 provided to them on the service machine. Listening to a script 411, they may be notified of several options including requesting access to complimentary air and water 430. Other options may include a maintenance request 420 and a billing request 425 which service station owners and operators may use to contact the machine operator. After selecting the option for an activation request 430, the user may be asked to enter the machine number 440. If the number is entered incorrectly or does not match records 441, they may be asked to enter the number again. The user may then be asked to enter the pump number 450. Again if the number is not valid 451, they may be asked to enter the number again. The user may then be prompted to enter the purchase price of their fuel 460, for example, without a decimal. If an invalid amount is entered, the user may be prompted to enter the number again. A number may also be rejected if it has already been redeemed at least once. The machine may then turn on and the user may begin using air and water 470.

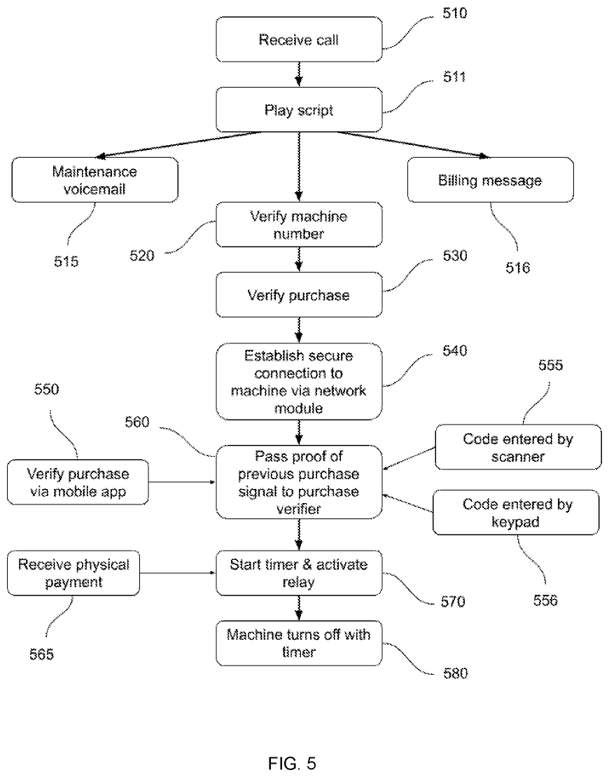

FIG. 5 shows an example of how the access control system might handle an interaction with a user. It is the same interaction, but from the system's perspective. Upon receiving a call 510, an interactive voice response (IVR) system may play a message 511. If the user selects an option for a maintenance request, the system may direct the user to leave a voice message 515. This user may be the seller of the auxiliary purchase, such as a service station operator. Similarly the system may communicate to the user information about billing or account requests 516. If the user selects an option requesting activation of the machine, the system directs the user to enter the service machine number and purchase confirmation code. The system then verifies the validity of the service machine number 520 and checks the purchase confirmation code against a database corresponding to the service machine number 530. These steps establish that the customer requesting activation of the machine indeed made a qualifying purchase. The system may then establish a connection to the machine by a network module 540 and push a proof of previous purchase signal to the purchase verifier 560. These signals may also be generated in response to purchase verification carried out by a mobile application 550, by a keypad 556 or code scanner 555 on the machine. The proof of previous purchase signal may then activate the timer and relay 570. The timer and relay 570 may also be activated in response to a signal from the physical payment interface by receipt of physical payment 565. The machine may then turn off or be deactivated when the timer expires 580, returning the machine to its initial state.

There are many variations on the kinds of information that can be used to confirm the previous purchase and how this information is communicated to the automated system 330. For example, an alphanumeric password or pass phrase may be provided on the receipt that can be spoken to a voice response system 320. Such a phrase can be recognized by the IVR or automated verification system and as valid and can be used to either uniquely identify a previous purchase or simply validate that the purchase was at a particular location and/or within a particular time range. Speech recognition technology has long surpassed the levels of performance to enable differentiation of pre-selected phrases, even using a generic voice model, and the phrases may be selected to be very easy to identify.

In a preferred embodiment, the previous purchase verifier 610 contains a network module to receive information relating to its verification function. The network module may be wireless and may operate over a local area network (LAN) or connect to the Internet via a cellular network or similar technology. In some embodiments, the network module enables the purchase verifier to receive a signal from a network attached computer system that receives at least some of the information required to verify a previous purchase. This information might be obtained over a telephone call by the user 300, as in the previous example, or may be obtained via the operation of a mobile app on the customer's phone 310.

The signal or network message received at the network module may be simple or detailed, depending on the application. For example, if a previous purchase has already been fully verified, the message can be anything or even empty. By confirming (by internet protocol address) that the sender of the message is a verification component on the network, the purchase verifier would need no further information. On the other extreme, the purchase verifier could be configured to require detailed information from the network to fully perform the verification function on the service machine itself. In such a case, data received at the network module might be structured, for example, in a human readable JavaScript Object Notation (JSON) format as follows:

```
{″previous purchase verification″: {
  ″source″: ″telephone″,
  ″month″: ″january″,
  ″day″: ″20″,
  ″time″: ″12:00:05″,
  ″purchase amount″: ″34.05″,
  ″pump″: ″3″
}}
```

Where unique, per-transaction, purchase verification codes are generated, the network module might enable newly generated codes to be quickly added to the list of currently valid codes within the previous purchase verifier. Optionally, these codes may expire after time, ensuring that the number of valid codes is not unbounded. The code may be provided in the form of a QR code or barcode printed on the customer's receipt. The customer may then scan the receipt with a phone or display it to a sensor on the service machine itself.

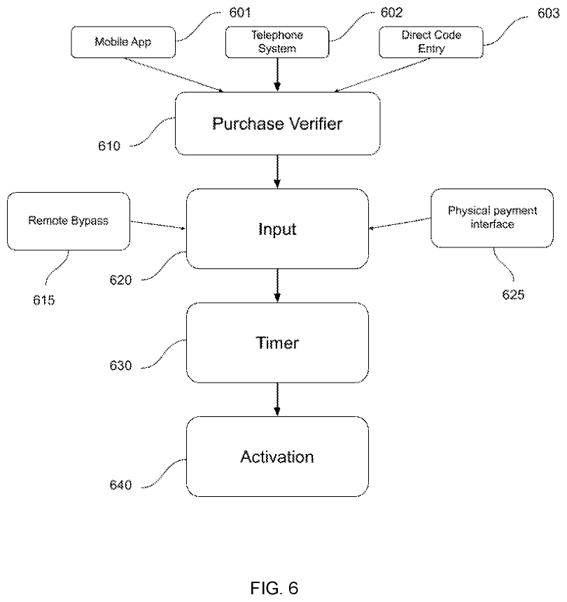

FIG. 6 shows the architecture for how an access control system may be constructed. A purchase verification system 610 may pass a proof of previous purchase signal to the machine. This purchase verifier may validate a purchase by a mobile or phone application 601, a telephone system 602, or by direct code entry 603, and by any combination thereof. Direct code entry 603 may include code scanners. This purchase verification system in turn may pass a signal to the machine input 620. The machine input 620 may also be passed a signal by a remote bypass 615 or by a physical payment module 625. This remote bypass 615 may take the form of a remote given to the machine owner or operator. This machine input 620 may then pass a signal to the timer 630. The timer may then begin providing the service 640, and turn on the machine for a period of time as designated by the machine operator. Turning on the machine may be accomplished by activating a relay or other switch.

While the present invention is very well suited for use in air and water machines, the flexible previous purchase verification mechanism described herein has significant utility beyond gas station industry. It is easy to consider its practical application within an electric vehicle charging station. For example, a restaurant may install a charging station in their parking lot. Patrons of the restaurant might receive free charging of their vehicle, and the restaurant would be able to collect revenue from non-customers. Similarly, the operator of a parking lot may wish to provide complimentary charging for those who purchase parking. Or those who are shopping or dining may use an embodiment of this invention to flexibly “validate” their parking. Other potential service machines which may benefit from the present invention include, but are not limited to: washing machines in laundromats, vending machines and casino chip dispensing machines.

For air and water machines and other service machine embodiments, it may be worth noting that the components unique to this invention may supplement traditional mechanisms for activating the service machines. An object of the present invention is to provide an activation path that enables activation based on authentication of a previous purchase. The invention can work well alongside other mechanisms new and old.

For example, network-based system may be bypassed by entering codes on a keypad. Codes may be loaded, stored, and changed at regular intervals, such as once per week. Codes also may be generated on the fly. Such a code could be provided on a purchase receipt, or provided by a clerk. This embodiment would simplify access to the machine for those with hearing disabilities. This embodiment also may allow machine owners to unlock the machine at their discretion, including for non-customers, by providing a code manually. At service stations in remote locations, there may be no wireless service and it may not be possible to communicate wirelessly to an off-site server. In such a scenario, the machine may be pre-programmed to accept certain codes. For instance, a keypad verification system may accept any code matching a pre-programmed code and pass a proof of previous purchase signal to the network module by a physical connection. This may allow customers to obtain complementary activation of the service machine without requiring any wireless connection. Pre-programmed codes may also be defined by exclusion, and accept any entered code except pre-defined obvious entries such as ‘0000’ or ‘1234’ which may prevent non-customers from obtaining access. Here, the verification module might have stored a list of commonly guessed codes for disqualification. As an effective alternative, the verification module might share some logic with the code generator such that only codes that share a certain property could be valid. For example, for 8 digit codes, you might require that the sum of the first and fourth digits plus 1 appear in the second and third digits (so a “12345678” code would automatically be invalidated but a “10645678” would not be because 1+4+1=6 or, as two digits, “06)”. Other digits might pertain to the day of the week or the week of the year. The point is that the set of valid codes could be varied in any number of ways that are both easy to confirm and not worth the effort required to reverse engineer. Sharing logic between the code generator and authenticator can make storing large numbers of valid or invalid codes unnecessary.

Finally, the wireless remotes typically used today might remain functional for those locations that desire one. Many locations may desire this feature so that they can have an extra degree of control in the case of multiple system failures, for example.

As for payment options when no qualifying previous purchase is available, a variety of payment methods may be accepted by the payment interface outside of the standard options of credit card, debit card, cash, and coins. These may include cryptocurrency. Payment may also be accepted by a mobile app or mobile wallet, such as Venmo, Google Pay or ApplePay. These systems could be configured to operate completely independently or there could be some value in consolidation of at least the hardware (and service) used to provide network communications.

Preferably, embodiments of the invention will include features to increase the safety of use. Machines controlled by remote may be turned on without regard to the physical status of the machine. While the machine operator is servicing the machine, a clerk may unintentionally activate the machine by remote, presenting a significant hazard to the technician. Alternatively, a clerk might intentionally activate the remote when they notice someone standing by the machine, intending to be helpful, without realizing that a technician is servicing the machine. This is particularly dangerous in the case of compressed air machines which incorporate fans and belts or electric vehicle charging stations which involve high voltages. The machine 330 may include door sensors or an “maintenance in progress” button which may disable the machine, allowing a technician to work safely.

The IoT-style connectivity that can be provided the network module can enable the machines to be deployed in smarter ways. For example, machines stored outside may reach extremely hot temperatures during the summer months, resulting in frequent electrical component failure. As such, it may be beneficial to incorporate a variety of sensors and leverage the network connectivity of the service machine. Such sensors may include thermometers and door sensors, but can also be as simple as a generalized maintenance button. These sensors can be used to detect the state of the machine and the network module can be used to communicate important information about the state of the machine to maintenance personnel. The metrics obtained can be transmitted continuously and with little to no delay, enabling the operators of the machine a detailed look at the machine's condition, both presently and within the context of place, time and circumstances. Such data points can be used to detect (or predict) component failures, vandalism and full coin containers. The physical payment interface may also transmit transaction data through the network module, allowing the machine operator to improve their financial accounting, detect physical currency theft, and intelligently schedule currency collection. The machine may be outfitted with sensors to detect pedestrian or vehicle traffic, providing some insight into the level of activity in a particular location (this activity level may or may not correlate to the levels of utilization on the machine itself). Prospectively, the data can also be used to help select locations for deploying additional machines.

Construction

As shown in FIG. 1, a typical service machine contains some components necessary to provide the service 120 130 and at least one component containing control logic 100 for determining when and how to provide the service. The present invention involves enhancing the control components and (optionally) providing additional sensors, as necessary, to obtain state information. One skilled in the art would readily be able to construct the present invention using existing techniques in the art further enabled by descriptions provided herein. Certain construction practices are preferred for service machine maintainability and space savings.

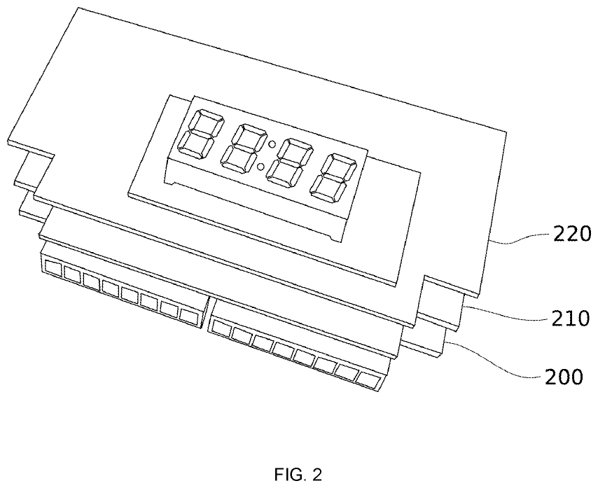

FIG. 2 shows a partial assembly of electronic components consistent with the present invention. In this example, the hardware takes the form of a series of printed circuit boards, that have been stacked. The board containing the central processing unit 200 is at the bottom. A board containing the modem or network module 210 is in the middle. The network module may contain a modem to connect to a cellular network under LTE, 3G or another appropriate data standard. The network module may instead (or in addition) be a wireless LAN module. In either case, a data connection can be created and, optionally, a virtual local area network defined enabling the module to communicate securely with components even outside the service machine. A board with a display for configuration 230 is at the top. It is preferable that the device consist of modular electrical components, allowing the replacement of single components when they fail. For example, relay components may fail at a rate higher than that of other components. By providing the relay in a module that detaches from the rest of the assembly, the maintenance expense of replacing a failed relay can be reduced because the remaining components may be reused. It is important to note that material costs may make up just a portion of the expense of replacement, as some components may require laborious on-site configuration. The device may be retrofitted to existing machines, or be made integral with the construction and installation of new machines.

While certain preferred embodiments have been illustrated and described for purposes of the present disclosure, numerous substitutions in components may be made by those skilled in the art. It is to be understood that the present invention may be practiced otherwise than as specifically described herein without departing from the scope and spirit thereof.

I claim:

1. A service machine comprising:
a payment interface operable to receive payment for a service;
a network module operable to receive a proof of previous purchase signal;
whereby said service is provided at least when said network module receives said proof of previous purchase signal.

2. The service machine of claim 1, further comprising user instructions to activate said service machine.

3. The service machine of claim 1, further comprising software to authenticate said proof of previous purchase signal.

4. The service machine of claim 1, wherein said proof of previous purchase signal is created in response to a telephone call.

5. The service machine of claim 1, wherein said proof of previous purchase signal is created in response to communication from a mobile application.

6. The service machine of claim 1, further comprising an input operable to receive an activation signal from a remote.

7. The service machine of claim 1, further comprising a keypad operable to receive a sequence of characters, the possession of said sequence of characters suggesting a previous purchase.

8. The service machine of claim 1, further comprising an optical sensor operable to detect a pattern, the possession of said pattern suggesting a previous purchase.

9. The service machine of claim 1, wherein said service is vehicular air and water.

10. The service machine of claim 1, wherein said service is electric vehicle charging.

11. The service machine of claim 1, further comprising a timer to limit the duration of service machine use.

12. The service machine of claim 1, wherein said payment interface is operable to receive cryptocurrency.

13. The service machine of claim 1, further comprising a plurality of sensors operable to communicate the state of said service machine using said network module.

14. The service machine of claim 13, wherein said sensors are operable to detect whether said service machine is being serviced, and further comprising a lockout operable to stop operation of the machine if said sensors detect the machine is being serviced.

15. A method for providing service machine access comprising:
providing at least one payment interface to said customer;
receiving evidence of a previous purchase;
validating said evidence of a previous purchase;
providing access to said service machine to said customer

16. The method of claim 15, wherein said evidence of a previous purchase is presented in the form of a code.

17. The method of claim 15, wherein said service machine is activated by a remote.

18. The method of claim 15, wherein said evidence of a previous purchase is received over a network.

19. The method of claim 15, wherein said evidence of a previous purchase is received over a network in response to a telephone call.

20. The method of claim 15, wherein said evidence of a previous purchase is received over a network in response to an action performed within a mobile/web application.
